(19) United States
(12) Patent Application Publication
(10) Pub. No.: US 2025/0112233 A1
(43) Pub. Date: Apr. 3, 2025

(54) CATHODE ACTIVE MATERIAL FOR LITHIUM ION SECONDARY BATTERY, LITHIUM ION SECONDARY BATTERY AND METHOD FOR MANUFACTURING CATHODE ACTIVE MATERIAL FOR LITHIUM ION SECONDARY BATTERY

(71) Applicant: HONDA MOTOR CO., LTD., Tokyo (JP)

(72) Inventor: Kazuki CHIBA, Saitama (JP)

(21) Appl. No.: 18/897,685

(22) Filed: Sep. 26, 2024

(30) Foreign Application Priority Data
Sep. 28, 2023 (JP) 2023-168780

(51) Int. Cl. H01M 4/525; C01G 53/00; H01M 4/02; H01M 4/505; H01M 10/0525

(52) U.S. Cl. CPC H01M 4/525; C01G 53/50; H01M 4/505; H01M 10/0525; C01P 2002/54; C01P 2002/72; C01P 2002/76; C01P 2002/86; C01P 2006/40; H01M 2004/028

(57) ABSTRACT

A cathode active material for a lithium ion secondary battery, including a lithium transition metal composite oxide as a main component,
wherein the lithium transition metal composite oxide is in a form of a particle having an outer layer on a surface of the particle, and
the lithium transition metal composite oxide is represented by the following Formula (1):

LiₘNiₓMn_{y}Zr_{z}O₂ (1)
wherein m is in a range of 1.0≤m≤1.04, x is in a range of 0.47<x<0.58, y is in a range of 0.40≤y<0.50, and z is in a range of 0<z<0.02, and
a ratio (Mn/Ni ratio) of the number of atoms of Mn to the number of atoms of Ni in the outer layer is 1.0 to 2.5.

### BACKGROUND

### Technical Field

The present invention relates to a cathode active material for a lithium ion secondary battery, a lithium ion secondary battery, and a method for manufacturing a cathode active material for a lithium ion secondary battery.

### Related Art

In recent years, research and development on secondary batteries that contribute to improvement of energy efficiency have been conducted. In particular, lithium ion secondary batteries are becoming increasingly important as power sources for electric vehicles (EV), hybrid electric vehicles (HEV), and the like.

A cathode active material has attracted attention as an important component for determining the capacity of a lithium ion secondary battery, and development thereof has been advanced. As a cathode active material used for a lithium ion secondary battery, for example, a composite oxide in which nickel and manganese in a lithium-nickel-manganese composite oxide are partially replaced with zirconium (Zr) has been reported (for example, Yao, et al., “Facile synthesis of Li₂ZrO₃-modified LiNi_{0.5}Mn_{0.5}O₂ cathode material from a mechanical milling route for lithium-ion batteries” Journal of Electroceramics. 43, 84 to 91 (2019), and WO 2020/209239 A).

### CITATION LIST

### Non Patent Literature

Non Patent Literature 1: Yao, et al., “Facile synthesis of Li₂ZrO₃-modified LiNi_{0.5}Mn_{0.5}O₂ cathode material from a mechanical milling route for lithium-ion batteries” Journal of Electroceramics. 43, 84 to 91 (2019)

### PATENT LITERATURE

Patent Literature 1: WO 2020/209239 A

### SUMMARY

In Yao, et al., “Facile synthesis of Li₂ZrO₃-modified LiNi_{0.5}Mn_{0.5}O₂ cathode material from a mechanical milling route for lithium-ion batteries” Journal of Electroceramics. 43, 84 to 91 (2019), and WO 2020/209239 A, the discharge capacity at 4.35 to 2.75 V is about 150 to 170 mAh/g, and there is room for improvement.

The present invention has been made to solve the problems as described above, and an object of the present invention is to provide a cathode active material for a lithium ion secondary battery in which a lithium ion secondary battery having a higher discharge capacity can be obtained, a lithium ion secondary battery using the cathode active material, and a method for manufacturing the cathode active material for a lithium ion secondary battery. In addition, this contributes to improvement in energy efficiency, accordingly.

To accomplish the above-described object, the present invention provides the following configuration.

[1]A cathode active material for a lithium ion secondary battery, including a lithium transition metal composite oxide as a main component, wherein
the lithium transition metal composite oxide is in a form of a particle having an outer layer on a surface of the particle, and
the lithium transition metal composite oxide is represented by the following Formula (1):

LiₘNiₓMn_{y}Zr_{z}O₂ (1)
wherein m is in a range of 1.0≤m≤1.04, x is in a range of 0.47<x<0.58, y is in a range of 0.40≤y<0.50, and z is in a range of 0<z<0.02, and
a ratio (Mn/Ni ratio) of the number of atoms of Mn to the number of atoms of Ni in the outer layer is 1.0 to 2.5.

The cathode active material for a lithium ion secondary battery according to [1] has a manganese-rich surface. Therefore, even if the content of Ni is reduced, the discharge capacity can be further increased. Therefore, in the lithium ion secondary battery using the cathode active material, the number of batteries required can be reduced, which can contribute to cost reduction. That is, it is possible to contribute to improvement of energy efficiency.

[2] The cathode active material for a lithium ion secondary battery according to [1], wherein a ratio (Ni/Zr ratio) of the number of atoms of Ni to the number of atoms of Zr in the outer layer is 6.50 to 17.5.

The cathode active material for a lithium ion secondary battery according to [2] has a zirconium (Zr)-rich surface. Therefore, an increase in Ni valence and a decrease in Mn valence can be suppressed, and the discharge capacity can be further enhanced. In addition, the cycle characteristics can be further enhanced. Therefore, it is possible to contribute to further improvement of energy efficiency.

[3] The cathode active material for a lithium ion secondary battery according to [1] or [2], wherein the cathode active material for a lithium ion secondary battery has a peak in a range of 500 to 800 ppm in a spectrum of the lithium transition metal composite oxide, measured by solid lithium nuclear magnetic resonance analysis (⁶Li-MAS-NMR) using a magic angle sample rotation method.

The cathode active material for a lithium ion secondary battery according to [3] has a peak in a range of 500 to 800 ppm. This means that Ni and Mn in the transition metal layer adjacent to Li—O₆ derived from a Li layer are uniformly solid-soluted. Therefore, it is possible to contribute to further improvement of energy efficiency.

[4] The cathode active material for a lithium ion secondary battery according to any one of [1] to [3], wherein the cathode active material for a lithium ion secondary battery has no peak in a range of 1475 to 1550 ppm in a spectrum of the lithium transition metal composite oxide, measured by solid lithium nuclear magnetic resonance analysis (⁶Li-MAS-NMR) using a magic angle sample rotation method.

The cathode active material for a lithium ion secondary battery according to [4] has no peak in a range of 1475 to 1550 ppm. This means that there is no peak attributed to Li₂MnO₃, indicating that there is no LiMn₆ domain in the transition metal layer. Therefore, it is possible to contribute to further improvement of energy efficiency.

[5] The cathode active material for a lithium ion secondary battery according to any one of [1] to [4], wherein the cathode active material for a lithium ion secondary battery has no peak in a range of 42°≤2θ≤43° in an X-ray diffraction pattern obtained using a Cu radiation source.

The cathode active material for a lithium ion secondary battery according to [5] has no peak in a range of 42°≤2θ≤43°. This means that there is no peak attributed to Li₂ZrO₃, indicating that Zr is solid-soluted in the lithium transition metal composite oxide. Therefore, it is possible to contribute to further improvement of energy efficiency.

[6] The cathode active material for a lithium ion secondary battery according to any one of [1] to [5], wherein in an X-ray diffraction pattern obtained using a Cu radiation source, peaks of a 108 plane and a 110 plane in a space group R-3m are split, and a full width at half maximum of the peak of the 110 plane is 0.10° to 0.21°.

In the cathode active material for a lithium ion secondary battery according to [6], peaks of a 108 plane and a 110 plane are split, and a full width at half maximum of the peak of the 110 plane is 0.100 to 0.21°. This indicates that Ni, Mn, and Zr are uniformly dispersed without phase separation. That is, it indicates that Ni, Mn, and Zr are solid-soluted in the lithium transition metal composite oxide without undergoing phase separation. Therefore, it is possible to contribute to further improvement of energy efficiency.

[7] The cathode active material for a lithium ion secondary battery according to any one of [1] to [6], wherein as lattice constants (a, c, c/a) of the lithium transition metal composite oxide in a space group R-3m, an a-axis length is 2.880 A to 2.900 Å, a c-axis length is 14.28 A to 14.30 Å, and c/a is 4.940 to 4.960.

In the cathode active material for a lithium ion secondary battery according to [7], the lattice constants satisfy a specific numerical range. Therefore, in the lithium transition metal composite oxide, lithium ions are easily diffused in the particles, and the resistance is low. Accordingly, it is possible to contribute to further improvement of energy efficiency.

[8]A lithium ion secondary battery including: a cathode; an anode; and an electrolyte, wherein the cathode contains the cathode active material for a lithium ion secondary battery according to any one of [1] to [7].

In the lithium ion secondary battery according to [8], the cathode contains the cathode active material for a lithium ion secondary battery. Therefore, the discharge capacity can be further increased, the number of batteries required can be reduced, which can contribute to cost reduction. That is, it is possible to contribute to improvement of energy efficiency.

[9]A method for manufacturing the cathode active material for a lithium ion secondary battery according to any one of [1] to [7],
the method including heat-treating a mixture of a lithium compound, a zirconium compound, and a nickel-manganese compound, or a mixture of a lithium compound and a nickel-manganese-zirconium compound at 1025° C. to 1150° C. for 1 minute to 7 hours.

A cathode active material for a lithium ion secondary battery satisfying the range of the chemical composition of the lithium transition metal composite oxide represented by Formula (1) and the Mn/Ni ratio in the outer layer can be manufactured by a method including the heat treatment process.

[10] The method for manufacturing the cathode active material for a lithium ion secondary battery according to [9], further including subsequently holding the obtained lithium transition metal composite oxide at 450° C. to 800° C. for 1 hour to 24 hours after the heat treatment.

By further providing the holding process (slow cooling process), a decrease in the valence of Mn in the lithium transition metal composite oxide can be suppressed, and a more stable structure can be obtained. Therefore, the discharge capacity can be further enhanced. In addition, the cycle characteristics can be further enhanced. Accordingly, it is possible to contribute to further improvement of energy efficiency.

According to the cathode active material for a lithium ion secondary battery, the lithium ion secondary battery, and the method for manufacturing a cathode active material for a lithium ion secondary battery of the present invention, the discharge capacity can be further increased.

### BRIEF DESCRIPTION OF DRAWINGS

FIG. 1 is a graph showing ⁶Li-MAS-NMR spectra of lithium transition metal composite oxides of Examples 1 and 2;

FIG. 2 is a view illustrating powder X-ray diffraction patterns of lithium transition metal composite oxides of Examples 1 and 2;

FIG. 3 is a cross-sectional view schematically illustrating a lithium ion secondary battery according to an embodiment of the present invention;

FIG. 4 is a graph showing charge and discharge curves of a lithium ion secondary battery using the lithium transition metal composite oxides of Examples 1 and 2;

FIG. 5 is a graph showing ⁶Li-MAS-NMR spectra of lithium transition metal composite oxides of Example 3 and Comparative Example 1;

FIG. 6 is a view illustrating powder X-ray diffraction patterns of lithium transition metal composite oxides of Example 3 and Comparative Example 1; and

FIG. 7 is a graph showing charge and discharge curves of a lithium ion secondary battery using the lithium transition metal composite oxides of Example 3 and Comparative Example 1.

### DETAILED DESCRIPTION

Hereinafter, preferred embodiments of the present invention will be described in detail with reference to the accompanying drawings.

### [Cathode Active Material for Lithium Ion Secondary Battery]

A cathode active material for a lithium ion secondary battery of this embodiment contains a lithium transition metal composite oxide as a main component, and is used for a cathode of a lithium ion secondary battery. The phrase “containing a lithium transition metal composite oxide as a main component” means that the content of the lithium transition metal composite oxide is 75% by mass or more, preferably 80% by mass or more, more preferably 90% by mass or more, and still more preferably 95% by mass or more with respect to the total mass of the cathode active material, and may be 100% by mass. The cathode active material for a lithium ion secondary battery may contain components other than the main component as long as the function of the present invention is not impaired.

The cathode active material for a lithium ion secondary battery of this embodiment may contain only one kind or two or more kinds of lithium transition metal composite oxides as long as the lithium transition metal composite oxide is contained as a main component.

When the cathode active material is manufactured by using the lithium transition metal composite oxide as a main component, a composition ratio (Li:Ni:Mn:Zr) of the entirety of the lithium transition metal composite oxide is also maintained in a cathode active material that is obtained. When the cathode active material obtained by using the lithium transition metal composite oxide having such a composition as a main component is used in a secondary battery, high capacity can be realized. In addition, the composition ratio of the lithium transition metal composite oxide is adjusted so as to be the same as a composition ratio required for the cathode active material to be obtained.

### (Lithium Transition Metal Composite Oxide)

The lithium transition metal composite oxide of this embodiment is a layered rock salt type oxide and is in the form of particles having an outer layer on the surface thereof.

In the present specification, the average particle size of the particle of the lithium transition metal composite oxide (hereinafter, also simply referred to as “average particle size”) is not particularly limited, but is, for example, preferably 0.25 to 10 μm, more preferably 0.25 to 5.0 μm, and still more preferably 0.50 to 2.5 μm. When the average particle size is the above-described lower limit value or more, the productivity of the cathode active material for a lithium ion secondary battery can be further enhanced. When the average particle size is the above-described upper limit value or less, the electrochemical characteristics of the lithium ion secondary battery can be further improved.

The average particle size means, for example, D50 measured by a laser diffraction particle size distribution measuring apparatus or the like.

### <Chemical Composition>

In a lithium transition metal composite oxide (for example, LiNi_{0.5}Mn_{0.5}O₂) in the related art, when Li is solid-soluted in a transition element, Ni²⁺ involved in an oxidation-reduction reaction is converted into Ni³⁺, and thus it is necessary to increase the amount of Ni used in order to improve electrochemical characteristics as a cathode active material. The present invention is based on the finding that an increase in the valence of Ni ions to 3 can be suppressed by adding Zr as a constituent element to LiNi_{0.5}Mn_{0.5}O₂ and replacing a part of Ni_{0.5}Mn_{0.5} with Li and Zr. Thus, in the present invention, the amount of Ni used can be reduced while the electrochemical characteristics of the cathode active material are maintained in a satisfactory manner.

The lithium transition metal composite oxide of this embodiment is represented by the following Formula (1).

LiₘNiₓMn_{y}Zr_{z}O₂ (1)

In Formula (1), m is in a range of 1.0≤m≤1.04, x is in a range of 0.47<x<0.58, y is in a range of 0.40≤y<0.50, and z is in a range of 0<z<0.02.

In the lithium transition metal composite oxide of this embodiment, it is more preferable that m is in a range of 1.02≤m≤1.04, x is in a range of 0.475≤x≤0.55, y is in a range of 0.45≤y≤0.475, and z is in a range of 0.005≤z≤0.015 in Formula (1). Specifically, the lithium transition metal composite oxide used in the present invention has a chemical composition in a range of Li_{1.02}Ni_{0.55}Mn_{0.475}Zr_{0.005}O₂ to Li_{1.04}Ni_{0.475}Mn_{0.45}Zr_{0.015}O₂.

The chemical composition of the lithium transition metal composite oxide of this embodiment can be determined by inductively coupled plasma (ICP) optical emission spectrometry.

### <Surface Composition>

The particle of the lithium transition metal composite oxide has an outer layer on the surface thereof.

In the present specification, the “outer layer” refers to a region up to 25 nm from the surface of the particle toward the inside of the particle. When the particle size is less than 50 nm, the particle has a single layer structure composed of only an outer layer.

In the particle of the lithium transition metal composite oxide of this embodiment, the content ratio of Mn is higher in the composition of the outer layer than in the composition of the central portion. The ratio (Mn/Ni ratio) of the number of atoms of Mn to the number of atoms of Ni in the outer layer of the lithium transition metal composite oxide of this embodiment is 1.0 to 2.5, preferably 1.0 to 2.0, and more preferably 1.0 to 1.8. When the Mn/Ni ratio is within the above-described numerical range, movement of lithium ions is not inhibited, and the charge and discharge capacity of the lithium ion secondary battery becomes high in a case of being used as a cathode active material.

The Mn/Ni ratio can be determined by quantitative analysis of X-ray photoelectron spectroscopy (XPS). According to the XPS, the composition of the manganese-rich surface in the entire particle can be analyzed. That is, an analysis result obtained by the XPS does not indicate a local composition of the entire surface of one particle, and indicates a composition of the entire surface of the particle.

The ratio (Ni/Zr ratio) of the number of atoms of Ni to the number of atoms of Zr in the outer layer of the lithium transition metal composite oxide of this embodiment is preferably 6.50 to 17.5, more preferably 6.75 to 17.5, and still more preferably 7.00 to 17.5. When the Ni/Zr ratio is within the above-described numerical range, the surface is rich in zirconium (Zr). Therefore, an increase in Ni valence and a decrease in Mn valence can be suppressed, and the discharge capacity can be further enhanced. In addition, the cycle characteristics can be further enhanced.

The Ni/Zr ratio can be determined by quantitative analysis of XPS.

The ratio (Mn/Zr ratio) of the number of atoms of Mn to the number of atoms of Zr in the outer layer of the lithium transition metal composite oxide of this embodiment is preferably 13.5 to 18.0, more preferably 13.5 to 17.5, and still more preferably 13.5 to 17.0. When the Mn/Zr ratio is within the above-described numerical range, the surface is rich in zirconium (Zr). Therefore, an increase in Ni valence and a decrease in Mn valence can be suppressed, and the discharge capacity can be further enhanced. In addition, the cycle characteristics can be further enhanced.

The Mn/Zr ratio can be determined by quantitative analysis of XPS.

The particles of the lithium transition metal composite oxide of this embodiment may be primary particles or secondary particles. From the viewpoint that relatively dense particles can be obtained, the particles of the lithium transition metal composite oxide are preferably secondary particles in which a plurality of primary particles are aggregated with each other.

### <Lattice Constant>

The lithium transition metal composite oxide of this embodiment is a layered compound of a rhombohedral crystal system, and has a crystal structure of a space group R-3m. With regard to the lattice constant of the lithium transition metal composite oxide, an a-axis length is preferably 2.880 A to 2.900 Å, a c-axis length is preferably 14.28 A to 14.30 Å, and c/a is preferably 4.940 to 4.960. When the lattice constants are within the above-described range, in the lithium transition metal composite oxide, lithium ions are likely to be diffused in primary particles, and resistance is low.

The lattice constants of the crystal can be determined by a least square method by measuring an X-ray diffraction pattern of the lithium transition metal composite oxide and using each index and plane spacing thereof.

### <Spectrum of ⁶Li-MAS-NMR>

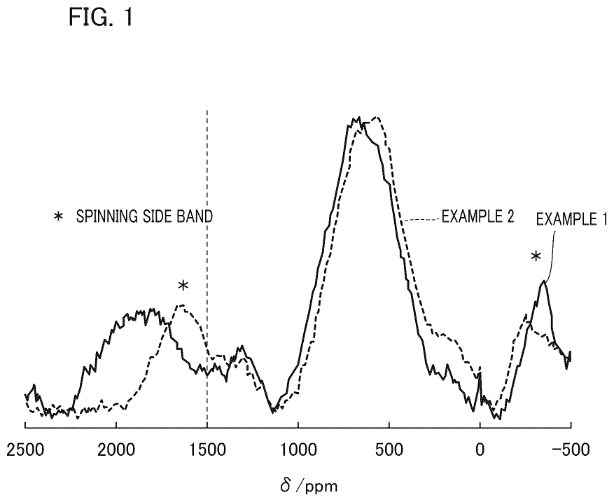

FIG. 1 shows solid lithium nuclear magnetic resonance (⁶Li-MAS-NMR) spectra of the lithium transition metal composite oxides (Examples 1 and 2) according to this embodiment. The solid line (Example 1) represents a spectrum after a heat treatment at 1100° C. for 5 minutes, and the broken line (Example 2) represents a spectrum after a heat treatment at 1100° C. for 5 minutes and further holding at 650° C. for 19 hours, at 550° C. for 19 hours, and at 450° C. for 19 hours. Each spectrum has a peak observed in a range of 500 to 800 ppm. This means that Ni and Mn in the transition metal layer adjacent to Li—O₆ derived from a Li layer are uniformly solid-soluted, indicating that Ni and Mn are uniformly dispersed in the lithium transition metal composite oxide, that is, Li is uniformly solid-soluted.

In the spectra shown in FIG. 1, there is no peak other than a ghost peak such as a spinning side band in a range of 1475 to 1550 ppm. This means that there is no peak attributed to Li₂MnO₃, indicating that there is no LiMn₆ domain in the transition metal layer. When Ni and Mn are not uniformly solid-soluted and a Mn-rich domain is formed, a peak attributed to Li₂MnO₃ is observed in a range of 1475 to 1550 ppm. The present inventors have confirmed that there is no peak other than a ghost peak in a range of 1475 to 1550 ppm by peak separation in the ⁶Li-MAS-NMR spectra shown in FIG. 1.

In FIG. 1, “*” means a spinning side band.

The ⁶Li-MAS-NMR spectra can be measured by a solid lithium nuclear magnetic resonance apparatus using a magic angle sample rotation method.

In the lithium transition metal composite oxide of this embodiment, Ni, Mn and Zr are uniformly solid-soluted, so that the charge and discharge capacity can be increased when the lithium transition metal composite oxide is used in a lithium ion secondary battery as a cathode active material.

### <X-Ray Diffraction (XRD) Pattern>

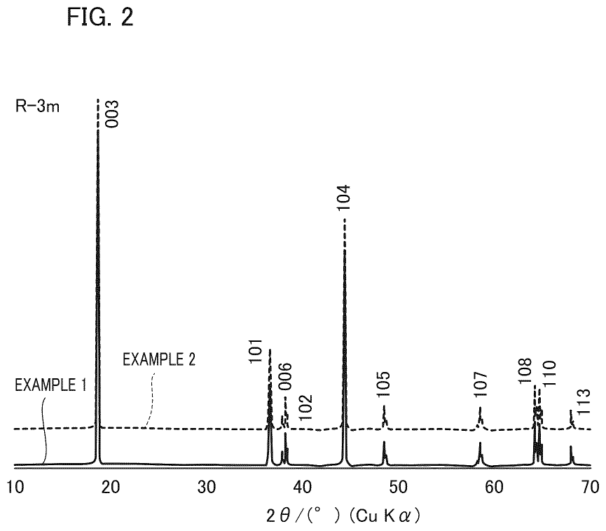

FIG. 2 illustrates X-ray diffraction (XRD) patterns of the lithium transition metal composite oxide (Li_{1.04}Ni_{0.475}Mn_{0.475}Zr_{0.01}O₂) according to this embodiment. Cu (copper) is used as a target to be irradiated with an electron beam, and Kα rays are used as characteristic X-rays. No peak attributed to the domain structure is observed in any of the pattern (solid line, Example 1) after a raw material mixture is heat-treated at 1100° C. for 5 minutes and the pattern (broken line, Example 2) after a raw material mixture is heat-treated at 1100° C. for 5 minutes and further held at 650° C. for 19 hours, 550° C. for 19 hours, and 450° C. for 19 hours. In particular, the XRD pattern of the lithium transition metal composite oxide of this embodiment has no peak in a range of 42 °≤2θ≤43°. This means that there is no peak attributed to Li₂ZrO₃, indicating that Zr is solid-soluted in the lithium transition metal composite oxide.

Further, in the XRD patterns of FIG. 2, the two peaks of the 108 plane and the 110 plane in the space group R-3m are split and clearly separated. This indicates that Ni, Mn, and Zr in the transition metal layer are uniformly dispersed without phase separation.

In FIG. 2, the full width at half maximum of the peak of the 110 plane in the space group R-3m is 0.100 to 0.21°. This indicates that Ni, Mn, and Zr in the transition metal layer are solid-soluted in the lithium transition metal composite oxide without undergoing phase separation. Note that the phrase “the full width at half maximum is 0.10° to 0.21°” means that the peak of the 110 plane in the space group R-3m is not tailed.

The full width at half maximum of the peak is obtained by analyzing the XRD pattern.

### [Method for Manufacturing Cathode Active Material for Lithium Ion Secondary Battery]

The cathode active material for a lithium ion secondary battery of this embodiment contains the above-described lithium transition metal composite oxide as a main component. As a lithium source of the lithium transition metal composite oxide, it is possible to use a known compound such as a hydroxide such as lithium hydroxide monohydrate (LiOH·H₂O), a carbonate such as lithium carbonate (Li₂CO₃), or an acetate such as lithium acetate (CH₃COOLi) and lithium acetate dihydrate (CH₃COOLi·2H₂O), and there is no particular limitation. In the compounds of the nickel source, a manganese source, and a zirconium source of the transition metal, known oxides, hydroxides, or metal salts of nickel, manganese, and zirconium can be widely used, and are not particularly limited.

For example, as the nickel compound, nickel hydroxide (Ni(OH)₂), nickel(II) chloride (NiCl₂), nickel(II) chloride hexahydrate (NiCl₂·6H₂O), and nickel(II) nitrate hexahydrate (Ni(NO₃)₂·6H₂O) can be used, but the nickel compound is not limited thereto.

As the manganese compound, manganese(II) chloride (MnCl₂), manganese(II) chloride tetrahydrate (MnCl₂·4H₂O), manganese carbonate hexahydrate (MnCO₃·6H₂O), manganese(II) nitrate hexahydrate (Mn(NO₃)₂·6H₂O) and the like can be used, but the manganese compound is not limited thereto.

As the zirconium compound, zirconium dioxide (ZrO₂), zirconium(IV) sulfate tetrahydrate (Zr(SO₄)₂·4H₂O), zirconium(IV) hydroxide (Zr(OH)₄), and the like can be used, but the zirconium compound is not limited thereto.

The transition metal compounds can be used alone and as a composite hydroxide (for example, nickel-manganese-zirconium composite hydroxide) or the like by using a coprecipitation method or the like.

The lithium transition metal composite oxide of this embodiment can be synthesized by using a known method. For example, a composite hydroxide or a composite oxide of a nickel compound and a manganese compound is prepared as an intermediate compound, the intermediate compound, a zirconium compound, and a lithium compound are mixed to obtain a raw material mixture, and the raw material mixture is heat-treated (for example, fired) at a predetermined temperature for a predetermined time in a predetermined atmosphere, whereby synthesis can be performed. In addition, a composite hydroxide or a composite oxide of a nickel compound, a manganese compound, and a zirconium compound is prepared as an intermediate compound, the intermediate compound and a lithium compound are mixed to obtain a raw material mixture, and the raw material mixture is heat-treated (for example, fired) at a predetermined temperature for a predetermined time in a predetermined atmosphere, whereby synthesis can also be performed.

It is preferable that the lithium transition metal composite oxide obtained in the heat treatment process is further held in a predetermined temperature range for a predetermined time by a slow cooling process. Since slow cooling conditions vary depending on treatment conditions (for example, a heat treatment atmosphere such as an oxygen atmosphere and an air atmosphere) and the like, it is preferable to appropriately adjust the slow cooling conditions. The present inventors have found that the transition metal of the lithium transition metal composite oxide is uniformly dispersed, and the Mn/Ni ratio on the particle surface can be increased by appropriately selecting the heat treatment conditions and the slow cooling conditions. Hereinafter, a method for manufacturing a cathode active material for a lithium ion secondary battery of this embodiment will be described in more detail with reference to an embodiment.

### (First Process)

In a first process, first, a predetermined amount of zirconium compound and a predetermined amount of lithium compound are added to a nickel-manganese compound as an intermediate, and the mixture is dispersed and mixed in a solvent such as ethanol. Note that, a predetermined amount of intermediate compound, a predetermined amount of zirconium compound, and a predetermined amount of lithium compound may be mixed not only by wet mixing using a solvent but also by dry mixing not using a solvent. For example, in a case of synthesizing Li_{1.04}Ni_{0.475}Mn_{0.475}Zr_{0.01}O₂ using zirconium dioxide (ZrO₂) as a zirconium compound and lithium carbonate (Li₂CO₃) as a lithium compound, Li₂CO₃ is preferably weighed more than the stoichiometric ratio by 1% by mass to 5% by mass, for example, 2% by mass. Similarly, in a case of synthesizing Li_{1.02}Ni_{0.475}Mn_{0.475}Zr_{0.01}O₂, Li₂CO₃ is preferably weighed more than the stoichiometric ratio by 1% by mass to 5% by mass, for example, 2% by mass.

The nickel-manganese compound can be synthesized by a known method. In a case where the nickel-manganese compound is a hydroxide, for example, nickel sulfate hexahydrate (NiSO₄·6H₂O) and manganese sulfate pentahydrate (MnSO₄·5H₂O) are weighed so that a molar ratio of Ni:Mn becomes 1:1, pure water is added thereto to dissolve the compounds, and an aqueous alkali solution is added dropwise to the aqueous sulfate solution to coprecipitate the compounds as a nickel-manganese composite hydroxide.

As the intermediate compound, a nickel-manganese-zirconium compound may be used instead of the nickel-manganese compound. For example, a predetermined amount of lithium compound is added to the nickel-manganese-zirconium compound, and the mixture is dispersed and mixed in a solvent such as ethanol. Note that, a predetermined amount of nickel-manganese-zirconium compound, and a predetermined amount of lithium compound may be mixed not only by wet mixing using a solvent but also by dry mixing not using a solvent. For example, in a case of synthesizing Li_{1.04}Ni_{0.475}Mn_{0.475}Zr_{0.01}O₂ by using lithium carbonate (Li₂CO₃) as a lithium compound, Li₂CO₃ is preferably weighed more than the stoichiometric ratio by 1% by mass to 5% by mass, for example, 2% by mass. Similarly, in a case of synthesizing Li_{1.02}Ni_{0.475}Mn_{0.475}Zr_{0.01}O₂, Li₂CO₃ is preferably weighed more than the stoichiometric ratio by 1% by mass to 5% by mass, for example, 2% by mass.

The nickel-manganese-zirconium compound can be synthesized using a known method. In a case where the nickel-manganese-zirconium compound is a hydroxide, for example, nickel sulfate hexahydrate (NiSO₄·6H₂O), manganese sulfate pentahydrate (MnSO₄·5H₂O), and zirconium(IV) sulfate tetrahydrate (Zr(SO₄)₂·4H₂O) are weighed so that the molar ratio of Ni:Mn Zr becomes 1:1:x (x is preferably 0.005 to 0.04), pure water is added thereto to dissolve the compounds, an aqueous alkali solution is added dropwise to the aqueous sulfate solution, and the compounds can be coprecipitated as a nickel-manganese-zirconium composite hydroxide.

As a precursor, a mixture of a lithium compound, a zirconium compound, and a nickel-manganese compound, or a mixture of a lithium compound and a nickel-manganese-zirconium compound is pulverized and mixed to a preferable size, and the mixture is filled in a crucible and is heat-treated. As the crucible, an alumina sagger, an alumina crucible, a platinum crucible, a gold crucible, or the like is used. In the heat treatment of the mixture, for example, a firing furnace or a roller hearth kiln is used.

The mixture put into the sagger or the crucible is heated to reach a heat treatment temperature at a temperature-rising rate of 5° C./min to 25° C./min, and preferably 10° C./min to 25° C./min. A heat treatment atmosphere is not particularly limited, and examples thereof include the atmosphere (under an air atmosphere), an oxygen flow, and the like. The heat treatment atmosphere is preferably the oxygen flow. A heat treatment time can be appropriately set in correspondence with the heat treatment temperature. The heat treatment time represents time for holding the heat treatment temperature.

In a case where a mixture of the lithium compound (for example, Li₂CO₃), the zirconium compound (for example, ZrO₂), and the nickel-manganese compound is heat-treated, the heat treatment temperature is preferably 1025° C. to 1150° C., and more preferably 1050° C. to 1125° C. The heat treatment time is preferably 1 minute to 7 hours, more preferably 2 minutes to 6 hours, still more preferably 3 minutes to 5 hours, and particularly preferably 5 minutes to 3 hours.

In a case where the mixture of the lithium compound (for example, Li₂CO₃) and the nickel-manganese-zirconium compound is heat-treated, the heat treatment temperature is preferably 1025° C. to 1150° C., and more preferably 1050° C. to 1125° C. The heat treatment time is preferably 1 minute to 7 hours, more preferably 2 minutes to 6 hours, still more preferably 3 minutes to 5 hours, and particularly preferably 5 minutes to 3 hours.

### (Second Process)

In a second process, a powder obtained after the heat treatment in the first process is cooled so as to reach 800° C. at a temperature-falling rate of 5° C./min to 25° C./min, and preferably 10° C./min to 25° C./min, and then the powder is held at 800° C. for 0.5 hours to 12 hours. The atmosphere for holding the powder at 800° C. is not particularly limited, and examples thereof include the atmosphere (under an air atmosphere), an air flow, and an oxygen flow.

The method for manufacturing the cathode active material for a lithium ion secondary battery of this embodiment may include a process of holding the powder at 750° C. for 0.5 hours to 12 hours after the second process. Even in this case, the powder held at 800° C. in the second process is cooled to reach 750° C. at a temperature-falling rate of 10° C./min, and then the powder is held at 750° C. for 0.5 hours to 12 hours. The atmosphere for holding the powder at 750° C. is not particularly limited, and examples thereof include the atmosphere (under an air atmosphere), an air flow, and an oxygen flow.

### (Third Process)

In a third process, the powder held at 750° C. in the second process is cooled so as to reach 700° C. at a temperature-falling rate of 5° C./min to 25° C./min, and preferably 10° C./min to 25° C./min, and then the powder is held at 700° C. for 0.5 hours to 12 hours. The atmosphere for holding the powder at 700° C. is not particularly limited, and examples thereof include the atmosphere (under an air atmosphere), an air flow, and an oxygen flow.

### (Fourth Process)

In a fourth process, the powder held at 700° C. in the third process is cooled so as to reach 650° C. at a temperature-falling rate of 5° C./min to 25° C./min, and preferably 10° C./min to 25° C./min, and then the powder is held at 650° C. for 0.5 hours to 12 hours. The atmosphere for holding the powder at 650° C. is not particularly limited, and examples thereof include the atmosphere (under an air atmosphere), an air flow, and an oxygen flow.

### (Fifth Process)

In a fifth process, the powder held at 650° C. in the fourth process is cooled so as to reach 600° C. at a temperature-falling rate of 5° C./min to 25° C./min, and preferably 10° C./min to 25° C./min, and then the powder is held at 600° C. for 0.5 hours to 20 hours. The atmosphere for holding the powder at 600° C. is not particularly limited, and examples thereof include the atmosphere (under an air atmosphere), an air flow, and an oxygen flow.

### (Sixth Process)

In a sixth process, the powder held at 600° C. in the fifth process is cooled so as to reach 400° C. to 500° C. at a temperature-falling rate of 10° C./min, and then the powder is held at 400° C. to 500° C. for 0.5 hours to 30 hours. The sixth process may be a process of holding the powder at 450° C. for 0.5 hours to 30 hours, and then holding the powder at 400° C. for 0.5 hours to 30 hours. In addition, the sixth process may be a process of holding the powder at 500° C. for 0.5 hours to 20 hours.

The slow cooling processes from the second process to the sixth process described above can be appropriately changed or omitted as necessary. In one embodiment, the slow cooling process is held at preferably 450° C. to 800° C., preferably 1 hour to 24 hours, more preferably 2 hours to 20 hours, and most preferably 19 hours after the heat treatment. The slow cooling process may be performed two or more times as long as the temperature to be held is lowered stepwise. The cathode active material for a lithium ion secondary battery of this embodiment can further increase the Mn/Ni ratio on the particle surface of the lithium transition metal composite oxide by appropriately selecting the slow cooling conditions.

### [Lithium Ion Secondary Battery]

The lithium ion secondary battery of this embodiment includes a cathode, an anode, and an electrolyte, and the cathode contains a cathode active material containing the above-described lithium transition metal composite oxide as a main component. The lithium ion secondary battery of this embodiment may include other battery elements as necessary.

In the lithium ion secondary battery of this embodiment, a known battery element of the lithium ion secondary battery can be employed as it is except that the cathode contains a cathode active material containing the above-described lithium transition metal composite oxide as a main component. The lithium ion secondary battery of this embodiment may have any of a coin type, a button type, a cylindrical type, a square type, and a laminate type. In addition, the lithium ion secondary battery of this embodiment is applicable to a wide range of applications such as mobile devices including mobile phones and notebook computers, and in-vehicle applications.

Hereinafter, with respect to the lithium ion secondary battery of this embodiment, a lithium ion secondary battery (coin-type lithium ion secondary battery) using an electrolytic solution will be described. Each battery element described below can be similarly applied to an all-solid-state lithium ion secondary battery not using an electrolytic solution.

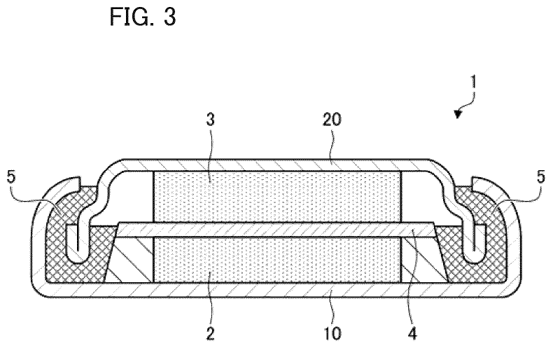

FIG. 3 is a cross-sectional view schematically illustrating a lithium ion secondary battery according to this embodiment. FIG. 3 illustrates an example in which the lithium ion secondary battery of this embodiment is a coin-type lithium ion secondary battery. As illustrated in FIG. 3, a lithium ion secondary battery 1 of this embodiment includes an anode can (anode terminal) 20, an anode 3, a separator 4 impregnated with an electrolytic solution, an insulating packing (gasket) 5, a cathode 2, and a cathode can 10.

The cathode can 10 is disposed on a lower side of the separator 4, the anode can 20 is disposed on an upper side of the separator 4, and the outer shape of the lithium ion secondary battery 1 is formed by the cathode can 10 and the anode can 20. The cathode 2 and the anode 3 are provided between the cathode can 10 and the anode can 20 with the separator 4 impregnated with an electrolytic solution interposed therebetween, and the cathode 2 and the anode 3 are separated from each other by the separator 4. The cathode can 10 and the anode can 20 are electrically insulated from each other by the insulating packing 5.

In the lithium ion secondary battery 1, a cathode mixture is prepared by blending a conductive agent, a binder, and the like with the cathode active material for a lithium ion secondary battery of this embodiment as necessary, and a cathode 2 can be manufactured by pressing the cathode mixture to a current collector (not shown).

As the current collector, a stainless steel mesh, an aluminum foil, or the like can be preferably used. As the conductive agent, acetylene black, ketjen black, or the like can be preferably used. As the binder, tetrafluoroethylene, polyvinylidene fluoride, or the like can be preferably used.

Blending of the cathode active material, the conductive agent, and the binder in the cathode mixture is not particularly limited. The content of the conductive agent in the cathode mixture is preferably 1% by mass to 15% by mass, and more preferably 0.1% by mass to 5% by mass. The content of the binder in the cathode mixture is preferably 0.1% by mass to 10% by mass, and more preferably 0.1% by mass to 5% by mass. It is preferable to blend the cathode active material, the conductive agent, and the binder such that the remainder (a portion other than the cathode active material and the conductive agent) in the cathode mixture becomes the cathode active material.

In the lithium ion secondary battery 1, as the anode 3 with respect to the cathode 2, a known electrode, for example, a metal-based material such as metallic lithium and a lithium alloy, a carbon-based material such as graphite and mesocarbon microbeads (MCMB), and a silicon-based material such as silicon (Si), a Si alloy, and silicon oxide, which functions as an anode active material and is capable of intercalating and deintercalating lithium, can be employed.

Known battery elements can be employed as the separator 4 and a battery container (cathode can 10 and anode can 20).

As the electrolyte, a known electrolytic solution, a known solid electrolyte, or the like can be employed. As the electrolytic solution, for example, a solution obtained by dissolving an electrolyte such as lithium perchlorate or lithium hexafluorophosphate in a solvent such as ethylene carbonate (EC), dimethyl carbonate (DMC), propylene carbonate (PC), or diethyl carbonate (DEC) can be used.

In addition, the all-solid-state lithium ion secondary battery can have a similar structure as in a known all-solid-state lithium ion secondary battery except that a cathode active material containing the above-described lithium transition metal composite oxide as a main component is used.

In the case of the all-solid-state lithium ion secondary battery, as the electrolyte, for example, solid electrolytes such as a polymer-based solid electrolyte such as a polyethylene oxide-based polymer compound and a polymer compound including at least one or more of a polyorganosiloxane chain and a polyoxyalkylene chain, a sulfide-based solid electrolyte, and an oxide-based solid electrolyte can be used.

For the cathode of the all-solid-state lithium ion secondary battery, for example, a cathode mixture containing a solid electrolyte in addition to the cathode active material, the conductive agent, and the binder can be carried on a cathode current collector such as aluminum, nickel, and stainless steel.

In the lithium ion secondary battery 1 of this embodiment, since the cathode 2 contains a cathode active material containing the above-described lithium transition metal composite oxide as a main component, high capacity can be realized.

### EXAMPLES

Next, examples of the present invention will be described, but the invention is not limited to these examples.

### Example 1

(Synthesis of Lithium-Nickel-Manganese-Zirconium Oxide: Li_{1.04}Ni_{0.475}Mn_{0.475}Zr_{0.01}O₂)

Li₂CO₃ (manufactured by Kojundo Chemical Lab. Co., Ltd.), Ni_{0.5}Mn_{0.5}(OH)₂, and Zr(OH)₄ (manufactured by Sigma-Aldrich Co. LLC) were weighed so that a ratio of Li:Ni Mn:Zr becomes 1.04:0.475:0.475:0.01 in terms of a molar ratio, and in consideration of Li evaporation, Li₂CO₃ was weighed to be rich by 3% by mass based on the stoichiometric ratio. The total mass of Li₂CO₃ (manufactured by Kojundo Chemical Lab. Co., Ltd.), Ni_{0.5}Mn_{0.5}(OH)₂, and Zr(OH)₄ (manufactured by Sigma-Aldrich Co. LLC.) was set to 2.1 g. The materials were dispersed and mixed in ethanol by a mortar. Thereafter, the resulting mixture was filled in a JIS standard platinum crucible. The mixture filled in the platinum crucible was heated in the air at a temperature-rising rate of 15° C./min and fired at 1100° C. for 5 minutes using a firing furnace, and then the obtained powder was left to stand until the temperature of the powder reached room temperature (25° C.) to obtain a lithium-nickel-manganese-zirconium oxide of Example 1.

### Example 2

(Synthesis of Lithium-Nickel-Manganese-Zirconium Oxide: Li_{1.04}Ni_{0.475}Mn_{0.475}Zr_{0.01}O₂)

Li₂CO₃ (manufactured by Kojundo Chemical Lab. Co., Ltd.), Ni_{0.5}Mn_{0.5}(OH)₂, and Zr(OH)₄ (manufactured by Sigma-Aldrich Co. LLC) were weighed so that a ratio of Li:Ni Mn:Zr becomes 1.04:0.475:0.475:0.01 in terms of a molar ratio, and in consideration of Li evaporation, Li₂CO₃ was weighed to be rich by 3% by mass based on the stoichiometric ratio. The total mass of Li₂CO₃ (manufactured by Kojundo Chemical Lab. Co., Ltd.), Ni_{0.5}Mn_{0.5}(OH)₂, and Zr(OH)₄ (manufactured by Sigma-Aldrich Co. LLC.) was set to 2.1 g. The materials were dispersed and mixed in ethanol by a mortar. Thereafter, the resulting mixture was filled in a JIS standard platinum crucible. The mixture filled in the platinum crucible was heated in the air at a temperature-rising rate of 15° C./min and fired at 1100° C. for 5 minutes by using a firing furnace to obtain a powder of a lithium-nickel-manganese-zirconium oxide.

The powder after the heat treatment was cooled so as to reach 650° C. at a temperature-falling rate of 10° C./min, and then the powder was held at 650° C. for 19 hours in the air. Next, the powder was cooled at a temperature-falling rate of 10° C./min so as to reach 550° C., and then the powder was held at 550° C. for 19 hours in the air. Further, the powder was cooled at a temperature-falling rate of 10° C./min so as to reach 450° C., and then the powder was held at 450° C. for 19 hours in the air. Thereafter, the powder was left to stand until the temperature of the powder reached room temperature (25° C.) to obtain a lithium-nickel-manganese-zirconium oxide of Example 2.

### Example 3

(Synthesis of Lithium-Nickel-Manganese-Zirconium Oxide: Li_{1.02}Ni_{0.57}Mn_{0.40}Zr_{0.01}O₂)

Li₂CO₃ (manufactured by Kojundo Chemical Lab. Co., Ltd.), Ni(OH)₂ (manufactured by Kojundo Chemical Lab. Co., Ltd.), Ni_{0.5}Mn_{0.5}(OH)₂, and Zr(OH)₄ (manufactured by Sigma-Aldrich Co. LLC) were weighed so that a ratio of Li:Ni Mn:Zr becomes 1.02:0.57:0.40:0.01 in terms of a molar ratio, and in consideration of Li evaporation, Li₂CO₃ was weighed to be rich by 2% by mass based on the stoichiometric ratio. The total mass of Li₂CO₃ (manufactured by Kojundo Chemical Lab. Co., Ltd.), Ni(OH)₂ (manufactured by Kojundo Chemical Lab. Co., Ltd.), Ni_{0.5}Mn_{0.5}(OH)₂, and Zr(OH)₄ (manufactured by Sigma-Aldrich Co. LLC.) was set to 2.1 g. The materials were dispersed and mixed in ethanol by a mortar. Thereafter, the resulting mixture was filled in a JIS standard platinum crucible. The mixture filled in the platinum crucible was heated in the air at a temperature-rising rate of 15° C./min and fired at 1050° C. for 30 minutes using a firing furnace, and then the obtained powder was left to stand until the temperature of the powder reached room temperature (25° C.) to obtain a lithium-nickel-manganese-zirconium oxide of Example 3.

### Comparative Example 1

(Synthesis of Lithium-Nickel-Manganese Oxide: Li_{1.04}Ni_{0.48}Mn_{0.48}O₂)

Li₂CO₃ (manufactured by Kojundo Chemical Lab. Co., Ltd.) and Ni_{0.5}Mn_{0.5}(OH)₂ (NARD Institute, Ltd.) were weighed so that a ratio of Li:Ni:Mn becomes 1.04:0.48:0.48 in terms of a molar ratio, and in consideration of Li evaporation, Li₂CO₃ was weighed to be rich by 2% by mass based on the stoichiometric ratio. The total mass of Li₂CO₃ (manufactured by Kojundo Chemical Lab. Co., Ltd.) and Ni_{0.5}Mn_{0.5}(OH)₂ (NARD Institute, Ltd.) was set to 2.1 g. The materials were dispersed and mixed in ethanol by a mortar. Thereafter, the resulting mixture was filled in a JIS standard platinum crucible. The mixture filled in the platinum crucible was heated in the air at a temperature-rising rate of 15° C./min and fired at 950° C. for 30 minutes using a firing furnace, and then the obtained powder was left to stand until the temperature of the powder reached room temperature (25° C.) to obtain a lithium-nickel-manganese oxide of Comparative Example 1.

### (Analysis)

A chemical composition of a sample obtained in Example 1 was analyzed by an ICP optical emission spectrometer (trade name: Agilent 5110 VDV, manufactured by Agilent Technologies, Inc.), and the results are shown in Table 1. As shown in Table 1, it was confirmed that Li Ni:Mn:Zr was 1.04:0.475:0.475:0.01.

In addition, an X-ray diffraction (XRD) pattern of the obtained sample was measured with a powder X-ray diffractometer (trade name: SmartLab, manufactured by Rigaku Corporation). Cu (copper) was used as a target to be irradiated with an electron beam, and Kα rays were used as characteristic X-rays. The lattice constants were determined by a least squares method using each index of the obtained XRD pattern and plane spacing thereof. When a space group of the obtained sample was set to R-3m, and the lattice constants were determined, a was 2.88560(4) Å, c was 14.2857(3) Å, and c/a was 4.9502. The full width at half maximum of the peak of the 110 plane in the space group R-3m was 0.1079 (17°). The powder X-ray diffraction pattern is shown in FIG. 2. The lattice constant and the full width at half maximum of the peak are shown in Table 1.

In addition, the results obtained by analyzing the composition of the surface layer of the obtained sample by quantitative analysis with an X-ray photoelectron spectroscopy (XPS) analyzer (trade name: K-Alpha⁺, manufactured by Thermo Fisher Scientific) are shown in Table 1. As shown in Table 1, the Mn/Ni ratio in the surface layer was 1.0. Measurement conditions of XPS measurement are shown below.

### <<XPS Measurement Conditions>>

Model used: Thermo Fisher Scientific,
K-Alpha⁺ (trade name)
Irradiation X-ray: single crystal spectroscopic AlKa (12 keV, 72 W)
X-ray spot diameter: 400 μm
Neutralization electron gun: used
Reference spectrum: C—C, C—H 284.6 eV
Detection depth: 6 to 7 nm

Further, the obtained samples of Examples 1 and 2 were analyzed by Li-MAS-NMR (trade name: AVANCE 300, manufactured by Bruker Corporation). The results are shown in FIG. 1. From the results shown in FIG. 1, it was confirmed that the samples of Examples 1 and 2 had a peak in a range of 500 to 800 ppm in the spectrum of ⁶Li-MAS-NMR.

In the samples of Examples 1 and 2, it was confirmed that there was no peak other than the spinning side band in a range of 1475 to 1550 ppm.

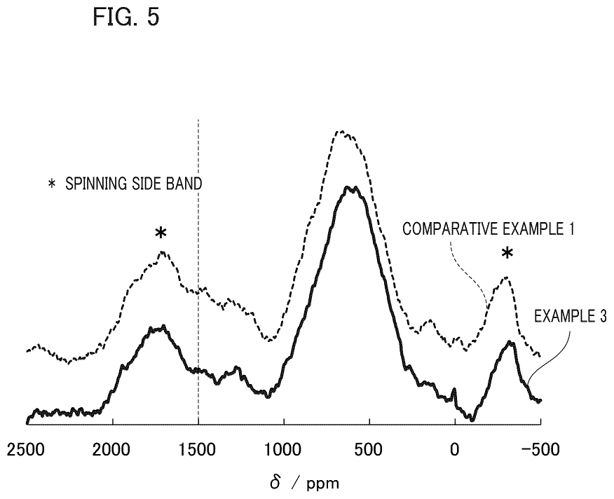

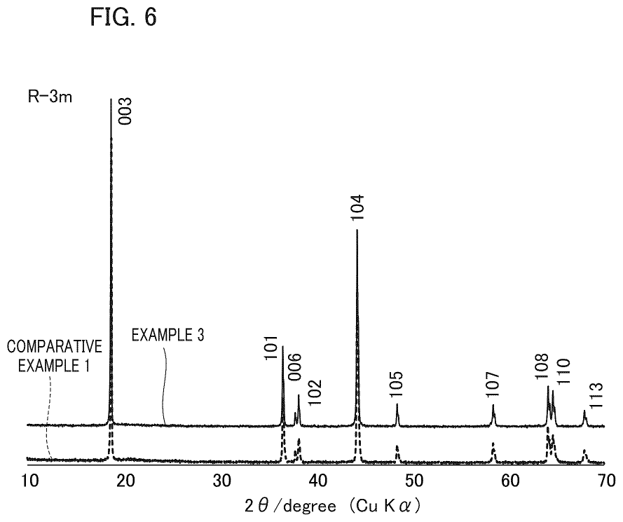

The samples obtained in Examples 2 to 3 and Comparative Example 1 were also subjected to ICP emission spectrometry, powder X-ray diffraction measurement, XPS analysis, and ⁶Li-MAS-NMR measurement in the same manner as in Example 1. The results are shown in Table 1, FIG. 2, FIG. 5, and FIG. 6. In Table 1, the “full width at half maximum (°)” represents the full width at half maximum of the peak of the 110 plane in the space group R-3m.

TABLE 1

| | | | | | Comparative |
|---|---|---|---|---|---|
| | | Example 1 | Example 2 | Example 3 | Example 1 |
| Chemical | Li | 1.04 | 1.04 | 1.02 | 1.04 |
| composition | Ni | 0.475 | 0.475 | 0.57 | 0.48 |
| (ICP) | Mn | 0.475 | 0.475 | 0.40 | 0.48 |
| | Zr | 0.01 | 0.01 | 0.01 | — |
| Heat treatment | | 1100° C. | 1100° C. | 1050° C. | 950° C. |
| process condition | | 5 min | 5 min | 30 min | 30 min |
| Presence or absence of | | No | Yes | No | No |
| slow cooling process | | | | | |
| Lattice | a(Å) | 2.88560(4) | 2.88598(4) | 2.88357(7) | 2.88404(7) |
| constant | c(Å) | 14.2857(3) | 14.2862(3) | 14.2758(5) | 14.2768(5) |
| | c/a | 4.9502 | 4.9507 | 4.9507 | 4.9503 |
| Full width at half | | 0.1079(17) | 0.1052(16) | 0.1480(10) | 0.224(6) |
| maximum of peak (°) | | | | | |
| Mn/Ni | Entire | 1.00 | 1.00 | 0.70 | 1.00 |
| ratio | particle | | | | |
| | Outer | 1.00 | 1.86 | 1.42 | 0.95 |
| | layer | | | | |
| Ni/Zr | Entire | 48 | 48 | 57 | — |
| ratio | particle | | | | |
| | Outer | 16.72 | 7.72 | 17.00 | — |
| | layer | | | | |
| Mn/Zr | Entire | 48 | 48 | 40 | — |
| ratio | particle | | | | |
| | Outer | 16.19 | 14.32 | 16.00 | — |
| | layer | | | | |

| | | | | |
|---|---|---|---|---|
| Initial discharge | 170 | 215 | 202 | 169 |
| capacity (mAh/g) | | | | |
| Capacity retention | 95 | 98 | 96 | 88 |
| ratio (%) | | | | |

From the XRD patterns shown in FIG. 2, it was confirmed that the samples of Examples 1 and 2 had no peak in a range of 420° 20 43°. In addition, in the samples of Examples 1 and 2, it was confirmed that the peaks of the 108 plane and the 110 plane in the space group R-3m were split. Further, as shown in Table 1, in the samples of Examples 1 and 2, the full width at half maximum of the peak of the 110 plane in the space group R-3m was 0.10° to 0.210.

As shown in FIG. 5, it was confirmed that the sample of Example 3 had a peak in a range of 500 to 800 ppm in the spectrum of ⁶Li-MAS-NMR. In the sample of Example 3, it was confirmed that there was no peak other than the spinning side band in a range of 1475 to 1550 ppm.

On the other hand, in the sample of Comparative Example 1 in which zirconium was not contained in the chemical composition and the Mn/Ni ratio of the outer layer was less than 1.0, a peak was observed in a range of 500 to 800 ppm but a peak was observed in a range of 1475 to 1550 ppm in the spectrum of ⁶Li-MAS-NMR.

As shown in FIG. 6, it was confirmed that the sample of Example 3 had no peak in a range of 42°≤2θ≤43°. In the sample of Example 3, it was confirmed that peaks of the 108 plane and the 110 plane in the space group R-3m were split. Further, as shown in Table 1, in the sample of Example 3, the full width at half maximum of the peak of the 110 plane in the space group R-3m was 0.10° to 0.21°.

On the other hand, in the sample of Comparative Example 1 in which zirconium was not contained in the chemical composition and the Mn/Ni ratio of the outer layer was less than 1.0, there was no peak in a range of 42°2 θ≤43°, but splitting of the peaks of the 108 plane and the 110 plane in the space group R-3m was not confirmed.

### [Production of Lithium Ion Secondary Battery]

The lithium-nickel-manganese-zirconium oxides of Examples 1 to 3 and the lithium-nickel-manganese oxide of Comparative Example 1 as a cathode active material, acetylene black (AB) as a conductive agent, and polyvinylidene fluoride (PVDF) as a binder were blended in a weight ratio of 8:1:1 by using N-methyl-2-pyrrolidone (NMP) as a solvent to prepare slurry. Thereafter, aluminum foil having a thickness of 15 μm was coated with the slurry and was dried to prepare a cathode having a diameter of 14 φ. A coating area density was set to 4.5 mg/cm², and a volume density was set to 2.3 g/cm³. With respect to the cathode, a lithium metal having a thickness of 200 μm and a diameter of 16 φ was used as a counter electrode, and a polyethylene microporous film having a thickness of 20 μm and a diameter of 18 φ was used as a separator. A 1.2 mol/L solution obtained by dissolving lithium hexafluorophosphate (LiPF₆) in a mixed solvent of ethylene carbonate (EC), dimethyl carbonate (DMC), and ethyl methyl carbonate (EMC) (volume ratio: 3:4:3) was used as an electrolytic solution, and a lithium ion secondary battery (2032 coin type cell) having the structure illustrated in FIG. 3 was prepared. The battery was manufactured in accordance with a known cell configuration and assembly method.

### [Charge and Discharge Test]

Each of the manufactured lithium ion secondary batteries was subjected to a charge and discharge test at a constant current at a rate of 0.05 C (1C: 250 mA/g), a current density of 12.5 mA/g, a cutoff potential of 4.7 V to 2.5 V or 4.8 V to 2.5 V under a temperature condition of 25° C. to evaluate an initial discharge capacity. The charge and discharge test was initiated from charging.

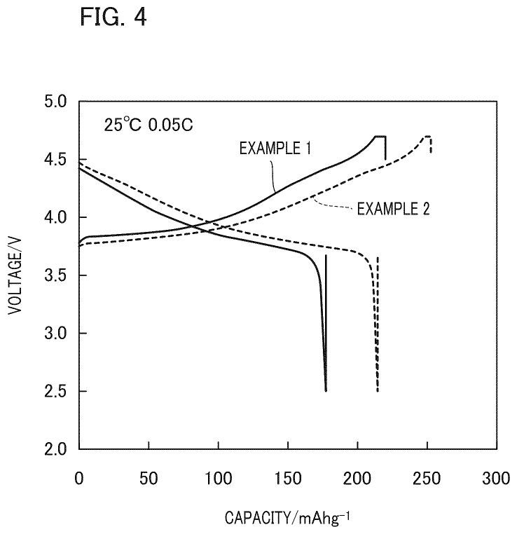

FIG. 4 illustrates charge and discharge curves in Examples 1 and 2. FIG. 4 illustrates a voltage change at the time of discharge in which the cell voltage decreases as the capacity increases, and a voltage change at the time of charge in which the cell voltage increases as the capacity increases.

As illustrated in FIG. 4, it could be understood that the lithium ion secondary battery using the lithium-nickel-manganese-zirconium oxide of Example 2 as a cathode active material had higher capacity in comparison to the lithium ion secondary battery using the lithium-nickel-manganese-zirconium oxide of Example 1 as a cathode active material. This is presumed to be because in Example 2, by performing the stepwise slow cooling processes, the constitution of the lithium-nickel-manganese-zirconium oxide becomes more stable, elution of Ni into the electrolytic solution can be suppressed, and the Mn/Ni ratio of the outer layer of the particles of the lithium-nickel-manganese-zirconium oxide can be further increased. Even in Example 1, if heat treatment conditions are appropriately selected, a higher capacity can be expected.

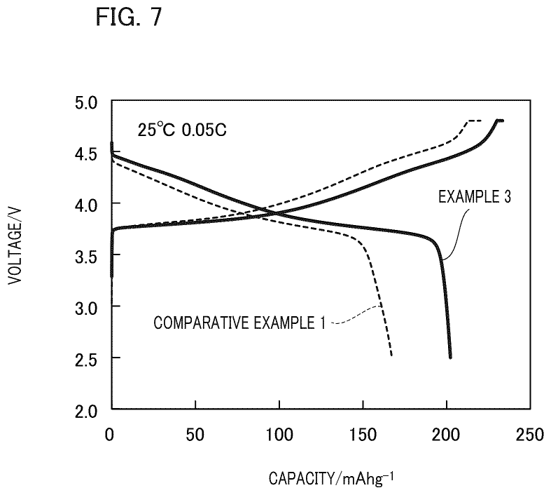

FIG. 7 illustrates charge and discharge curves in Example 3 and Comparative Example 1. FIG. 7 illustrates a voltage change at the time of discharge in which the cell voltage decreases as the capacity increases, and a voltage change at the time of charge in which the cell voltage increases as the capacity increases.

As illustrated in FIG. 7, it could be understood that the lithium ion secondary battery using the lithium-nickel-manganese-zirconium oxide of Example 3 as a cathode active material had higher capacity in comparison to the lithium ion secondary battery using the lithium-nickel-manganese oxide of Comparative Example 1 as a cathode active material.

### [Cycle Test]

After the initial discharge capacity evaluation, each of the manufactured lithium ion secondary batteries was subjected to a cycle test 100 times at a current density of 12.5 mA/g and a cutoff potential of 4.3 V to 2.5 V under a temperature condition of 25° C., and a capacity retention ratio (discharge capacity at the 100th cycle/discharge capacity at the 1st cycle) was evaluated. The charge and discharge test was initiated from charging. The results are shown in Table 1. A higher capacity retention ratio indicates better cycle characteristics.

As shown in Table 1, the lithium ion secondary batteries of Examples 1 to 3 to which the present invention was applied exhibited a high capacity retention ratio of 95% or more.

On the other hand, the capacity retention ratio of the lithium ion secondary battery of Comparative Example 1 containing no zirconium in the chemical composition and having a Mn/Ni ratio of the outer layer of less than 1.0 was 88%.

From the above results, it was found that according to the present invention, it is possible to provide a cathode active material for a lithium ion secondary battery capable of further increasing the discharge capacity and a lithium ion secondary battery containing the cathode active material.

What is claimed is:

1. A cathode active material for a lithium ion secondary battery, comprising a lithium transition metal composite oxide as a main component, wherein
the lithium transition metal composite oxide is in a form of a particle having an outer layer on a surface of the particle, and
the lithium transition metal composite oxide is represented by the following Formula (1):
LiₘNiₓMn_{y}Zr_{z}O₂ (1)
wherein m is in a range of 1.0≤m≤1.04, x is in a range of 0.47<x<0.58, y is in a range of 0.40≤y<0.50, and z is in a range of 0<z<0.02, and
a ratio (Mn/Ni ratio) of the number of atoms of Mn to the number of atoms of Ni in the outer layer is 1.0 to 2.5.

2. The cathode active material for a lithium ion secondary battery according to claim 1, wherein a ratio (Ni/Zr ratio) of the number of atoms of Ni to the number of atoms of Zr in the outer layer is 6.50 to 17.5.

3. The cathode active material for a lithium ion secondary battery according to claim 1, wherein the cathode active material for a lithium ion secondary battery has a peak in a range of 500 to 800 ppm in a spectrum of the lithium transition metal composite oxide, measured by solid lithium nuclear magnetic resonance analysis (⁶Li-MAS-NMR) using a magic angle sample rotation method.

4. The cathode active material for a lithium ion secondary battery according to claim 1, wherein the cathode active material for a lithium ion secondary battery has no peak in a range of 1475 to 1550 ppm in a spectrum of the lithium transition metal composite oxide, measured by solid lithium nuclear magnetic resonance analysis (⁶Li-MAS-NMR) using a magic angle sample rotation method.

5. The cathode active material for a lithium ion secondary battery according to claim 1, wherein the cathode active material for a lithium ion secondary battery has no peak in a range of 42°≤2θ≤43° in an X-ray diffraction pattern obtained using a Cu radiation source.

6. The cathode active material for a lithium ion secondary battery according to claim 1, wherein in an X-ray diffraction pattern obtained using a Cu radiation source, peaks of a 108 plane and a 110 plane in a space group R-3m are split, and a full width at half maximum of the peak of the 110 plane is 0.10° to 0.21°.

7. The cathode active material for a lithium ion secondary battery according to claim 1, wherein as lattice constants (a, c, c/a) of the lithium transition metal composite oxide in a space group R-3m, an a-axis length is 2.880 Å to 2.900 Å, a c-axis length is 14.28 Å to 14.30 Å, and c/a is 4.940 to 4.960.

8. A lithium ion secondary battery comprising:
a cathode;
an anode; and
an electrolyte,
wherein the cathode contains the cathode active material for a lithium ion secondary battery according to claim 1.

9. A method for manufacturing the cathode active material for a lithium ion secondary battery according to claim 1,
the method comprising heat-treating a mixture of a lithium compound, a zirconium compound, and a nickel-manganese compound, or a mixture of a lithium compound and a nickel-manganese-zirconium compound at 1025° C. to 1150° C. for 1 minute to 7 hours.

10. The method for manufacturing the cathode active material for a lithium ion secondary battery according to claim 9, further comprising subsequently holding the obtained lithium transition metal composite oxide at 450° C. to 800° C. for 1 hour to 24 hours after the heat treatment.
